(19) United States
(12) Patent Application Publication
(10) Pub. No.: US 2014/0290291 A1
(43) Pub. Date: Oct. 2, 2014

(54) COOLING SYSTEM FOR SPOT WELDING DEVICE

(71) Applicant: Hyundai Motor Company, Seoul (KR)

(72) Inventors: Hyun Jung Ryu, Seoul (KR); Dong Myong KIM, Hwaseong-si (KR)

(73) Assignee: Hyundai Motor Company, Seoul (KR)

(21) Appl. No.: 14/144,388

(22) Filed: Dec. 30, 2013

(30) Foreign Application Priority Data
Mar. 26, 2013 (KR) 10-2013-0032188

(51) Int. Cl. B23K 37/00

(52) U.S. Cl. CPC B23K 37/003
USPC 62/190; 62/259.2

(57) ABSTRACT

A cooling system for a spot welding device which cools heating parts of a spot welding device including two electrodes, a gun body, and a transformer, may include an air compressor, an air separator connected with the air compressor and separating compressed air supplied from the air compressor into hot air and cooling air, and a connection line supplying the cooling air separated by the air separator to a heating part of the spot welding device.

### CROSS-REFERENCE TO RELATED APPLICATION

The present application claims priority to Korean Patent Application No. 10-2013-0032188 filed on Mar. 26, 2013, the entire contents of which is incorporated herein for all purposes by this reference.

### BACKGROUND OF THE INVENTION

1. Field of the Invention

An exemplary embodiment of the present invention relates to a cooling system for a spot welding device. More particularly, the present invention relates to a cooling system for a spot welding device which can cool a heating portion of a spot welding device with cooling air.

2. Description of Related Art

In general, several parts such as panels are bonded by spot welding in the assembly line of a vehicle body factory. Spot welding is a welding method of bonding objects to weld, using electric resistance by applying electricity and pressure to the object to weld which overlap.

A spot welding device is used for the spot welding and basically includes a fixed electrode and a moving electrode on a gun body.

The spot welding device performs spot welding on object to weld, using electric resistance by pressing the object to weld supported on the fixed electrode by operating the movable electrode with an actuator, and by applying electric resistance to the fixed electrode and the moving electrode.

On the other hand, since the spot welding device perform spot welding on object to weld, using electric resistance through the fixed electrode and the moving electrode, heat is generated at the fixed electrode and the moving electrode. Accordingly, the spot welding device is equipped with a cooling system for continuously removing the heat.

The cooling system is a water-cooled cooling system that supplies a coolant, which is supplied at a predetermined pressure from the outside, to the fixed electrode and the moving electrode and removes heat generated at the fixed electrode and the moving electrode, and a transformer as well.

The water-cooled cooling system of the spot welding device includes a coolant supply hose and a coolant discharge hose, for example, on a robot with a spot welding device thereon, and circulates a coolant to heating parts of the spot welding device through the supply hose and the discharge hose, using a coolant pump etc.

However, since the water-cooled cooling system of the spot welding device has a structure that circulates a coolant to the heating parts of the spot welding device, there is a limitation in space for installing coolant utilities such as the coolant pump and the cost of initial investment and maintenance for the coolant utilities may be increased.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a cooling system for a spot welding device having advantages of being able to cool heating parts of a spot welding device, using cooling air produced with a simple configuration without coolant utilities.

In an aspect to the present invention, a cooling system for a spot welding device for cooling heating parts of a spot welding device including two electrodes, a gun body, and a transformer, may include an air compressor, an air separator connected with the air compressor and separating compressed air supplied from the air compressor into hot air and cooling air, and a connection line connected to the air separator and supplying the cooling air separated by the air separator to the heating parts of the spot welding device.

The air separator may include a vortex tube apparatus having an inlet through which the compressed air is introduced, an energy converting unit converting kinetic energy of the compressed air into thermal energy and separating the compressed air into the hot air and the cooling air, a first discharge unit through which the hot air is discharged, and a second discharge unit through which the cooling air is discharged.

The second discharge unit is connected to the two electrodes through the connection line.

The second discharge unit is connected with the transformer on the gun body through the connection line.

A cooling air flow space through which the cooling air flows is defined in the two electrodes.

The two electrodes respectively may have an air inlet connected to the connection line for introducing the cooling air into the cooling air flow space through the connection line, and an air outlet for discharging the cooling air passing through the cooling air flow space to the outside.

An inner tube is disposed in the two electrodes and connected to the connection line such that the cooling air flows through the inner tube.

The two electrodes respectively may have an air inlet connected to the connection line for supplying the cooling air to the inner tube through the connection line, and an air outlet for discharging the cooling air passing through the inner tube to the outside.

The system may further include a compressed air supply line connecting the inlet with the air compressor, wherein a solenoid valve is disposed in the compressed air supply line.

The system may further include a temperature sensor sensing temperatures of the two electrodes and outputting sensing signals to the controller.

The controller opens or closes the solenoid valve in accordance with the sensing signals from the temperature sensor.

A temperature control valve is disposed in the connection line connecting the second discharge unit with the two electrodes.

In another aspect of the present invention, a cooling system for a spot welding device for cooling heating parts of a spot welding device including two electrodes, a gun body, and a transformer, may further include an air compressor, an air separator connected with the air compressor and separating compressed air supplied from the air compressor into hot air and cooling air, and a connection line connected to the air separator and supplying the cooling air separated by the air separator to a heating part of the spot welding device, wherein the two electrodes respectively have an air inlet connected to the connection line for injecting the cooling air, an air outlet for discharging the cooling air to the outside, and an inner tube disposed in the two electrodes and connected with the air inlet, wherein a flow space through which the cooling air flows is formed in the two electrodes.

The system may further include a compressed air supply line connecting the air separator with the air compressor, a solenoid valve disposed in the compressed air supply line, a temperature sensor sensing temperatures of the two electrodes and outputting sensing signals, and a controller controlling operation of the solenoid valve in accrodance with the output signals from the temperature sensor.

The system may further include a temperature control valve disposed in the connection line, wherein the controller controls operation of the temperature control valve in accrodance with the output signals from the temperature sensor.

The air separator may include a vortex tube apparatus having an inlet connetced to the air compressor and through which the compressed air is introduced, an energy converting unit converting kinetic energy of the compressed air into thermal energy and separating the compressed air into the hot air and the cooling air, a first discharge unit through which the hot air is discharged, and a second discharge unit through which cooling air is discharged.

According to exemplary embodiments of the present invention, it is possible to separate compressed air into hot air and cooing air, using a vortex tube, which is an air separator, and to cool heating parts of the spot welding device with the cooling air.

Therefore, since coolant utilities such as a coolant pump and a coolant pipe of the related art can be removed in an exemplary embodiment of the present invention, it is possible to reduce the cost of initial investment and maintenance and to increase usability of a welding space.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing a cooling system for a spot welding device according to an exemplary embodiment of the present invention.

FIG. 2 is a view showing an air separator that is used in the cooling system for a spot welding device according to an exemplary embodiment of the present invention.

FIG. 3 is a view showing a cooling structure of a moving electrode and a fixed electrode that are used in the cooling system for a spot welding device according to an exemplary embodiment of the present invention.

FIG. 4 is a view showing a transformer that is used in the cooling system for a spot welding device according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

The unrelated parts to the description of the exemplary embodiments are not shown to make the description clear and like reference numerals designate like element throughout the specification.

Further, the sizes and thicknesses of the configurations shown in the drawings are provided selectively for the convenience of description, so that the present invention is not limited to those shown in the drawings and the thicknesses are exaggerated to make some parts and regions clear.

Discriminating the names of components with the first, the second, etc. in the following description is for discriminating them for the same relationship of the components and the components are not limited to the order in the following description.

Throughout the specification, unless explicitly described to the contrary, the word “Compris” and variations such as “Comprises” or “Comprising”, will be understood to imply the inclusion of stated elements but not the exclusion of any other elements.

Further, the terms, “ . . . unit”, “ . . . mechanism”, “ . . . portion”, “ . . . member” etc. used herein mean the unit of inclusive components performing at least one or more functions or operations.

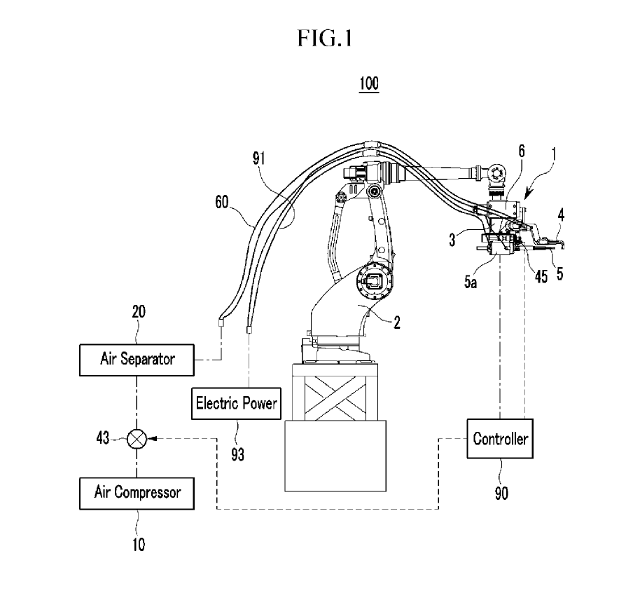

FIG. 1 is a view schematically showing a cooling system for a spot welding device according to an exemplary embodiment of the present invention.

Referring to FIG. 1, a cooling system 100 for a spot welding device according to an exemplary embodiment of the present invention can be used for a spot welding device 1 that performs spot welding on several parts such as vehicle body panels in a vehicle body assembly line.

For example, the spot welding device 1 includes a gun body 3 mounted at the arm end of a welding robot 2 and electrodes 4 and 5 that are first welding tips fixed at the gun body 3.

The electrodes 4 and 5 may be a fixed electrode 4 and a moving electrode 5 mounted to be able to reciprocate on the gun body 3 in correspondence to the fixed electrode 4.

The moving electrode 5 can be reciprocated with respect to the fixed electrode 4 by an actuator 5a at the gun body 3.

The spot welding device 1 further includes a transformer 6 mounted on the gun body 3, converting power into welding current, and supplying the welding current to the fixed electrode 4 and the moving electrode 5.

The spot welding device 1 is a bidirectional spot welding system which is widely known in the art and thus the configuration is not described in detail herein.

The cooling system for a spot welding device according to an exemplary embodiment of the present invention can make it possible to remove coolant utilities of the related art, and can cool heating parts of the spot welding device 1, using cooling air produced with a simple configuration.

That is, in an exemplary embodiment of the present invention, cooling air can be produced and supplied to heat parts of the spot welding device 1, for example, the fixed electrode 4, the moving electrode 5, and the transformer 6.

The cooling system 100 for a spot welding device according to an exemplary embodiment of the present invention basically includes an air compressor 10, an air separator 20, a connection line 60, and a controller 90.

The air compressor 10, which is usually disposed at a work area in a vehicle body assembly line, supplies air compressed at a predetermined pressure (compressed air) to the air separator 20.

The air separator 20 is provided for separating the compressed air supplied from the air compressor 10 into hot air and cold air (hereafter, referred to as “cooling air”).

The air separator 20 is connected with the air compressor 10 and can supply the cooling air to heating parts of the spot welding device 1, such as the fixed electrode 4, the moving electrode 5, and the transformer 6.

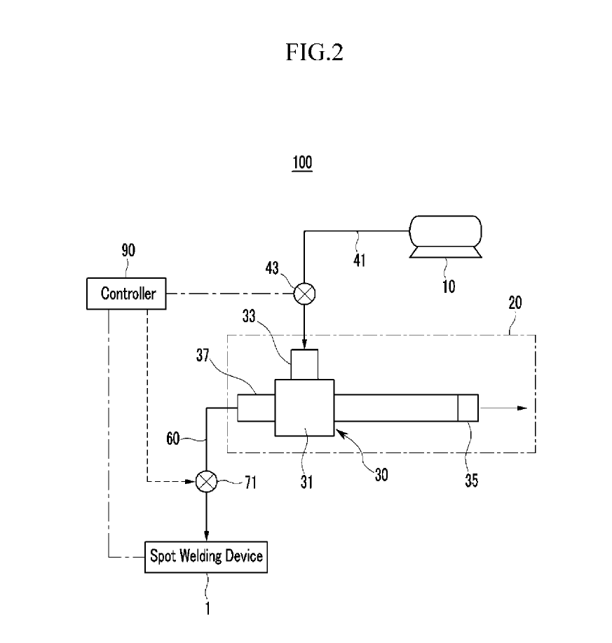

FIG. 2 is a view schematically showing an air separator that is used in the cooling system for a spot welding device according to an exemplary embodiment of the present invention.

Referring to FIGS. 1 and 2, the air separator 20 according to an exemplary embodiment of the present invention may include a vortex tube 30 separating predetermined fluid (compressed air in an exemplary embodiment of the present invention) into heating fluid (hot air in an exemplary embodiment of the present invention) and cooling fluid (cooling air in an exemplary embodiment of the present invention).

The vortex tube 30 includes an energy converting unit 31 that converts kinetic energy of the compressed air supplied from the air compressor 10 into thermal energy and separates the compressed air into hot air and cooling air.

The vortex tube 30 includes an inlet 33 through which the compressed air is introduced, a first discharge unit 35 through which the hot air is discharged, and a second discharge unit 37 through which the cooling air is discharged. A conical nozzle is disposed in the first discharge unit 35.

When the compressed air supplied from the air compressor 10 is introduced into the energy converting unit 31 through the inlet 33, the vortex tube 30 can convert the kinetic energy of the compressed air into thermal energy and separate the compressed air into hot air and cooling air through the energy converting unit 31.

The vortex tube 30 discharges the hot air separated from the compressed air through the first discharge unit 35 and the cooling air through the second discharge unit 37.

The vortex tube 30 is a common vortex tube that converts the kinetic energy of predetermined fluid into thermal energy and separates the fluid into heating fluid and cooling fluid, such that the detailed description of the configuration is not provided herein.

The inlet 33 of the vortex tube 30 can be connected with the air compressor 10 through the compressed air supply line 41. A solenoid valve 43 operating in response to an electric control signal from the controller 90 is disposed in the compressed air supply line 41.

The spot welding device 1 is equipped with a temperature sensor 45 that senses the temperature of the fixed electrode 4 and the moving electrode 5. The temperature sensor 45 senses the temperature of the fixed electrode 4 and the moving electrode 5 and outputs sensing signals to the controller 90.

The controller 90 can selectively open/close the channel of the compressed air supply line 41 by controlling the operation of the solenoid valve 43 in accordance with the sensing signals from the temperature sensor 45.

For example, the controller 90 can receive temperature measurement values for the fixed electrode 4 and the moving electrode 5 from the temperature sensor 45 and supply an electric control signal to the solenoid valve 43 in accordance with the temperature measurement values by comparing the temperature measurement values with predetermined reference temperature.

That is, when the temperature measurement value is the reference temperature or more, the controller 90 can open the channel of the compressed air supply line 41, using the solenoid valve 43 by supplying an On-signal to the solenoid valve 43. The reference temperature may be defined as temperature where a heating part requires to be cooled.

When the temperature measurement value is less than the reference temperature, the controller 90 can close the channel of the compressed air supply line 41, using the solenoid valve 43 by supplying an Off-signal to the solenoid valve 43.

The connection line 60 according to an exemplary embodiment of the present invention is provided for supplying cooling air, which is discharged through the second discharge unit 37, to a heating part of the spot welding device 1.

The connection line 60 may be a metal tube or a rubber hose connecting the second discharge unit 37 of the vortex tube 30 with the heating part of the spot welding device 1.

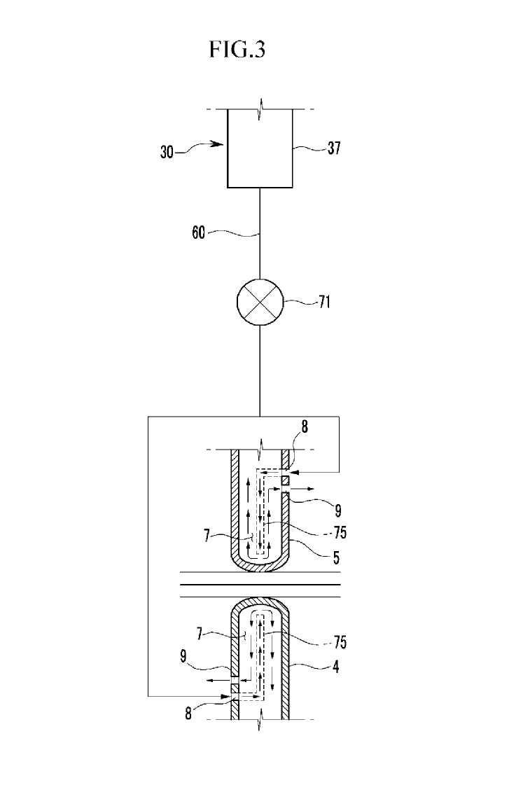

In an exemplary embodiment of the present invention, the connection line 60 may be separately connected to the fixed electrode 4 and the moving electrode 5, as shown in FIG. 3, in order to separately cool the fixed electrode 4 and the moving electrode 5 of the spot welding device 1 with the cooling air supplied from the vortex tube 30.

A cooling air flow space 7 through which the cooling air flows is defined in the fixed electrode 4 and the moving electrode 5. That is, an inner tube 75 is disposed in the tips of the electrodes 4 and 5 and the inner tube 75 defines the cooling air flow space 7.

An air inlet 8 for injecting cooling air into the flow space 7 through the connection line 60 and an air outlet 9 for discharging the cooling air passing through the cooling air flow space 7 to the outside are formed at the fixed electrode 4 and the moving electrode 5.

The connection line 60 supplies cooling air to the cooling air flow space 7, that is, the inner tube 75 through the air inlet 8.

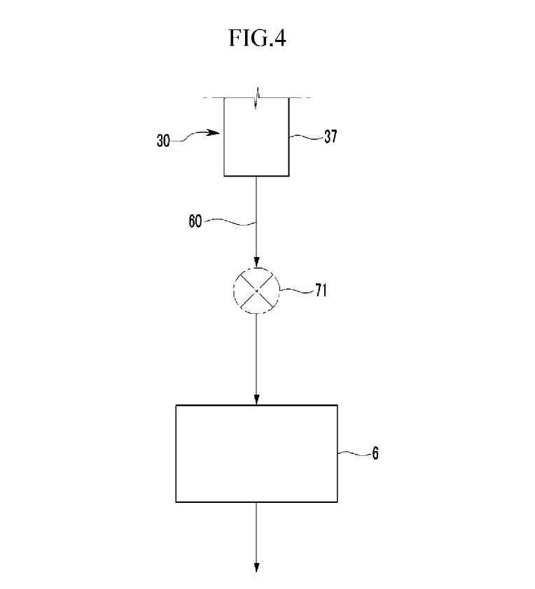

The connection line 60 may be connected to the transformer 6, as shown in FIG. 4, to cool the transformer 6 of the spot welding device 1 with the cooling air supplied from the vortex tube 30.

In this configuration, the connection line 60 is connected to the housing of the transformer 6 and can supply cooling air into the housing. Further, an outlet (not shown in the figures) for discharging the cooling air that is heated through the transformer 6 is formed at the housing.

As shown in FIGS. 2 and 3, a temperature control valve 71 may be disposed in the connection line 60 connecting the second discharge unit 37 of the vortex tube 30 with the fixed electrode 4 and the moving electrode 5 of the spot welding device 1.

The temperature control valve 71 is attached to a predetermined fluid supply pipe and controls the flow of fluid in accordance with the temperature of the fluid.

That is, the temperature control valve 71 can supply the cooling air keeping a predetermined temperature to the fixed electrode 4 and the moving electrode 5 through the connection line 60 by opening the channel of the connection line 60 within the range of predetermined temperature conditions of the cooling air supplied from the vortex tube 30.

For example, assuming that the pressure of the compressed air is about 5.5 bar, the temperature control valve 71 can open the channel of the connection line 60 when the temperature of the cooling air is about 26.2° C. below zero.

The reference numeral ‘91’ not stated in the FIG. indicates a power wire for supplying electric power 93 to the transformer 6.

The operation of the cooling system 100 for a spot welding device according to an exemplary embodiment of the present invention which has the configuration described above is described in detail with reference to the drawings.

First, in an exemplary embodiment of the present invention, while spot welding is performed on objects to be welded by the fixed electrode 4 and the moving electrode 5 of the spot welding device 1, the temperature sensor 45 senses the temperature of the fixed electrode 4 and the moving electrode 5 and outputs sensing signals to the controller 90.

Then, the controller 90 supplies an electric control signal to the solenoid valve 43 in accordance with the temperature measurement values sensed by the temperature sensor 45 by comparing the temperature measurement values with a predetermined reference temperature.

When the temperature measurement value is the reference temperature or more, an On-signal is supplied to the solenoid valve 43 from the controller 90 and the channel of the compressed air supply line 41 opens.

In contrast, when the temperature measurement value is less than the reference temperature, an Off-signal is supplied to the solenoid valve 43 from the controller 90 and the channel of the compressed air supply line 41 can close.

As described above, when the temperature measurement value sensed by the temperature sensor 45 is the reference temperature or more, the air compressed by the air compressor 10 is supplied to the inlet 33 of the vortex tube 30 through the compressed air supply line 41.

When the compressed air is supplied to the inlet 33 of the vortex tube 30, the vortex tube 30 converts the kinetic energy of the compressed air into thermal energy through the energy converting unit 31 and separates the compressed air into hot air and cooling air.

The hot air separated from the compressed air is discharged through the first discharge unit 35 and the cooling air is discharged through the second discharge unit 37.

The cooling air discharged through the second discharge unit 37 is supplied to the connection line 60 and the temperature control valve 71 in the connection line 60 can open the channel of the connection line 60 within the range of predetermined temperature conditions of the cooling air supplied from the vortex tube 30. Accordingly, the controller 90 can control the opening/closing of the temperature control valve 71.

For example, assuming that the pressure of the compressed air is about 5.5 bar, the temperature control valve 71 can open the channel of the connection line 60 when the temperature of the cooling air is about 26.2° C. below zero.

Accordingly, the cooling air is injected into the cooling air flow spaces 7 of the electrodes through the air inlets 8 of the fixed electrode 4 and the moving electrode 5 through the connection line 60, and then cools the fixed electrode 4 and the moving electrode 5.

Further, the cooling air heated through the cooling air flow spaces 7 is discharged to the outside through the air outlets 8 of the fixed electrode 4 and the moving electrode 5.

Further, in an exemplary embodiment of the present invention, it is possible to cool the transformer 6 with the cooling air by supplying the cooling air into the housing of the transformer 6 through the connection line 60.

Accordingly, according to the cooling system 100 for a spot welding device according to an exemplary embodiment of the present invention described above, it is possible to separate the compressed air into hot air and cooling air, using the vortex tube 30, which is air separator 20, and to cool heating parts of the spot welding device 1 with the cooling air.

Therefore, since coolant utilities such as a coolant pump and a coolant pipe of the related art can be removed in an exemplary embodiment of the present invention, it is possible to reduce the cost of initial investment and maintenance and to increase usability of a welding space.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. They are not intended to be exhaustive or to limit the invention to the precise forms disclosed, and obviously many modifications and variations are possible in light of the above teachings as well as various alternatives and modifications thereof. It is intended that the scope of the invention be defined by the Claims appended hereto and their equivalents.

What is claimed is:

1. A cooling system for a spot welding device for cooling heating parts of a spot welding device including two electrodes, a gun body, and a transformer, the system comprising:
an air compressor;
an air separator connected with the air compressor and separating compressed air supplied from the air compressor into hot air and cooling air; and
a connection line connected to the air separator and supplying the cooling air separated by the air separator to the heating parts of the spot welding device.

2. The system of claim 1, wherein the air separator includes a vortex tube apparatus having:
an inlet through which the compressed air is introduced;
an energy converting unit converting kinetic energy of the compressed air into thermal energy and separating the compressed air into the hot air and the cooling air;
a first discharge unit through which the hot air is discharged; and
a second discharge unit through which the cooling air is discharged.

3. The system of claim 2, wherein the second discharge unit is connected to the two electrodes through the connection line.

4. The system of claim 3, wherein the second discharge unit is connected with the transformer on the gun body through the connection line.

5. The system of claim 2, wherein a cooling air flow space through which the cooling air flows is defined in the two electrodes.

6. The system of claim 5, wherein the two electrodes respectively have:
an air inlet connected to the connection line for introducing the cooling air into the cooling air flow space through the connection line; and
an air outlet for discharging the cooling air passing through the cooling air flow space to the outside.

7. The system of claim 2, wherein an inner tube is disposed in the two electrodes and connected to the connection line such that the cooling air flows through the inner tube.

8. The system of claim 7, wherein the two electrodes respectively have:
an air inlet connected to the connection line for supplying the cooling air to the inner tube through the connection line; and
an air outlet for discharging the cooling air passing through the inner tube to the outside.

9. The system of claim 2, further comprising a compressed air supply line connecting the inlet with the air compressor, wherein a solenoid valve is disposed in the compressed air supply line.

10. The system of claim 9, further comprising a temperature sensor sensing temperatures of the two electrodes and outputting sensing signals to the controller.

11. The system of claim 10, wherein the controller opens or closes the solenoid valve in accordance with the sensing signals from the temperature sensor.

12. The system of claim 2, wherein a temperature control valve is disposed in the connection line connecting the second discharge unit with the two electrodes.

13. A cooling system for a spot welding device for cooling heating parts of a spot welding device including two electrodes, a gun body, and a transformer, the system comprising:
an air compressor;
an air separator connected with the air compressor and separating compressed air supplied from the air compressor into hot air and cooling air; and
a connection line connected to the air separator and supplying the cooling air separated by the air separator to a heating part of the spot welding device;
wherein the two electrodes respectively have:
an air inlet connected to the connection line for injecting the cooling air;
an air outlet for discharging the cooling air to the outside; and
an inner tube disposed in the two electrodes and connected with the air inlet, wherein a flow space through which the cooling air flows is formed in the two electrodes.

14. The system of claim 13, further comprising:
a compressed air supply line connecting the air separator with the air compressor;
a solenoid valve disposed in the compressed air supply line;
a temperature sensor sensing temperatures of the two electrodes and outputting sensing signals; and
a controller controlling operation of the solenoid valve in accrodance with the output signals from the temperature sensor.

15. The system of claim 14, further comprising a temperature control valve disposed in the connection line, wherein the controller controls operation of the temperature control valve in accrodance with the output signals from the temperature sensor.

16. The system of claim 15, wherein the air separator includes a vortex tube apparatus having:
an inlet connetced to the air compressor and through which the compressed air is introduced;
an energy converting unit converting kinetic energy of the compressed air into thermal energy and separating the compressed air into the hot air and the cooling air;
a first discharge unit through which the hot air is discharged; and
a second discharge unit through which cooling air is discharged.
